(19) United States
(12) Patent Application Publication
(10) Pub. No.: US 2012/0246893 A1
(43) Pub. Date: Oct. 4, 2012

(54) FASTENER

(76) Inventor: James R. Martellotti, Tustin, CA (US)

(21) Appl. No.: 13/432,479

(22) Filed: Mar. 28, 2012

Related U.S. Application Data
(60) Provisional application No. 61/468,461, filed on Mar. 28, 2011.

(51) Int. Cl. F16B 1/00

(52) U.S. Cl. 24/596.1; 24/591.1

(57) ABSTRACT

A fastener that consists of two components that snap into engagement with one another and that can be used to hold two or more pieces of material together. Each identical part includes a hole or opening running through it that allows for the parts to be disconnected or disengaged from one another. Thus, the fastener can be reused by re-engaging the multiple parts.

### CROSS REFERENCE TO RELATED APPLICATIONS

This application claims the benefit under 35 U.S.C. §119(e) of U.S. Provisional Patent Application No. 61/468,461, entitled “Fastener,” filed on Mar. 28, 2011, which is herein incorporated by reference in its entirety for all purposes.

### BACKGROUND OF THE INVENTION

Many types of multi-part fasteners are implemented with two or more different parts or components that are configured to mate or interlock with one another and to then be disconnected for reuse. Using different parts to implement a fastener, however, requires that different spare components be available in the event one of the components of the fastener is lost or broken. The use of different components, therefore, increases the complexity and cost of the fastener. While there are fasteners available that use two identical parts to snap together, they are not designed to be releasable and reused.

There is, therefore, a need for a fastener that addresses the cost and complexity of multi-part fasteners, that is also capable of being released and, therefore, reused.

### BRIEF SUMMARY OF THE INVENTION

A fastener that consists of two identical parts that snap into engagement with one another and which can be used to hold two or more parts together. Each part includes a hole or opening running through it that allows for two connected parts to be disconnected or disengaged from one another. Thus, advantageously, the fastener can be reused by re-engaging the multiple parts. In addition, as the two parts are identical, there need only be one type of replacement part in stock for the fastener.

In one embodiment, a fastener includes a cylindrical body with first and second ends and first and second engaging structures extending from the first end. Each of the first and second engaging structures comprises a first ratchet portion that is ratchedly connectable to a corresponding ratchet portion of another fastener.

The cylindrical housing may be a hollow piece of material with a lumen running through. A solid cap may be attached to the second end of the cylindrical housing where the solid cap has a diameter larger than a diameter of the cylindrical housing. The cap may have an opening in it where the opening is in line with the lumen of a hollow housing.

### BRIEF DESCRIPTION OF THE SEVERAL VIEWS OF THE DRAWINGS

Various aspects of at least one embodiment of the present invention are discussed below with reference to the accompanying figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. For purposes of clarity, not every component may be labeled in every drawing. The figures are provided for the purposes of illustration and explanation and are not intended as a definition of the limits of the invention. In the figures:

FIGS. 1 and 2 are perspective views of a fastener part in accordance with an embodiment of the present invention;

FIG. 3 is bottom view of the fastener part shown in FIGS. 1 and 2;

FIG. 4 is top view of the fastener part shown in FIGS. 1 and 2;

FIG. 5 is cut-away perspective view of a portion of the fastener part shown in FIGS. 1 and 2;

FIGS. 6A-6D are perspective views of two fastener parts coupled together;

FIGS. 7A and 7B are cut-away views of two fastener parts coupled together;

FIGS. 8A, 8B and 9 show an application of the fastener parts of the present invention;

FIG. 10 represents operation of a removal tool for separating two fastener parts from one another;

FIGS. 11A and 11B are perspective views of a fastener part in accordance with an embodiment of the present invention;

FIG. 12 is a perspective view of two fasteners as shown FIGS. 11A and 11B coupled to one another; and

FIGS. 13A and 13B are cut-away views of the two fastener parts of FIG. 12 coupled together.

### DETAILED DESCRIPTION OF THE INVENTION

This application claims the benefit under 35 U.S.C. §119(e) of U.S. Provisional Patent Application No. 61/468,461, entitled “Fastener,” filed on Mar. 28, 2011, which is herein incorporated by reference in its entirety for all purposes.

In the following detailed description, numerous specific details are set forth in order to provide a thorough understanding of the embodiments of the present invention. It will be understood by those of ordinary skill in the art that these embodiments of the present invention may be practiced without some of these specific details. In other instances, well-known methods, procedures, components and structures may not have been described in detail so as not to obscure the embodiments of the present invention.

Prior to explaining at least one embodiment of the present invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

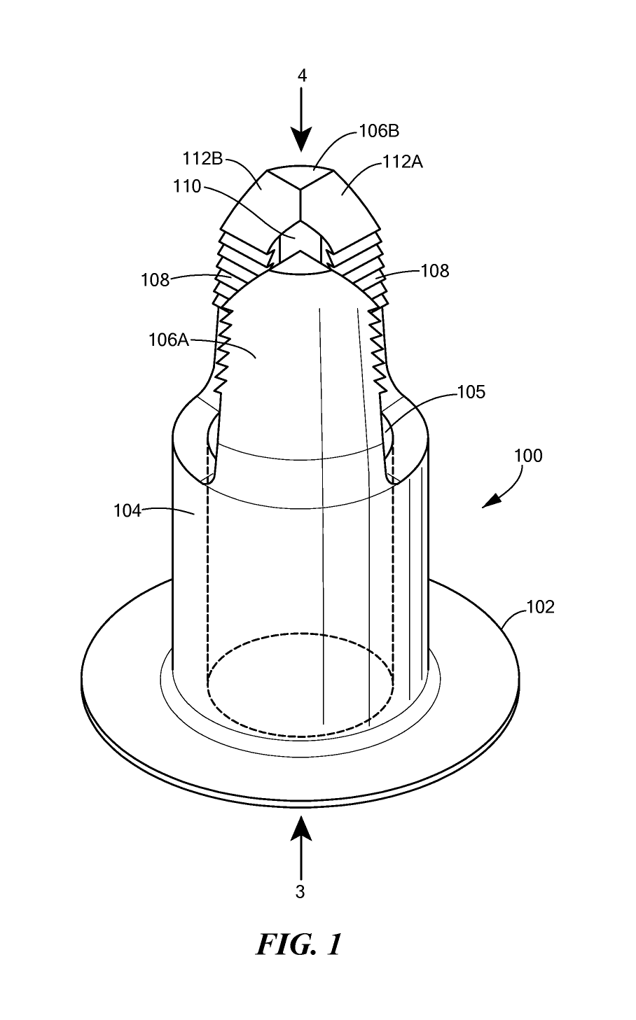

Referring now to FIG. 1, a part 100, in accordance with one embodiment of the present invention, includes an extension rim 102, or cap, connected to a hollow cylindrical body 104. The extension rim or cap may be integral with the body 104 or a separate part that is attached to the body 104. Two identical prongs 106A, 106B, or engaging structures, extend from the cylindrical body 104 and are in opposition to one another. An opening 105 runs through the cylindrical body 104 with a corresponding hole in the extension rim 102. Each prong 106A, 106B includes two longitudinal rows of teeth 108, i.e., a ratchet portion, disposed about a removal tool guide portion 110. Each prong 106A, 106B includes two orientation surfaces 112A, 112B that are used to guide the prongs 106 from one part 100 into a space between the prongs 106 of another part 100 when connected, as will be described in more detail below.

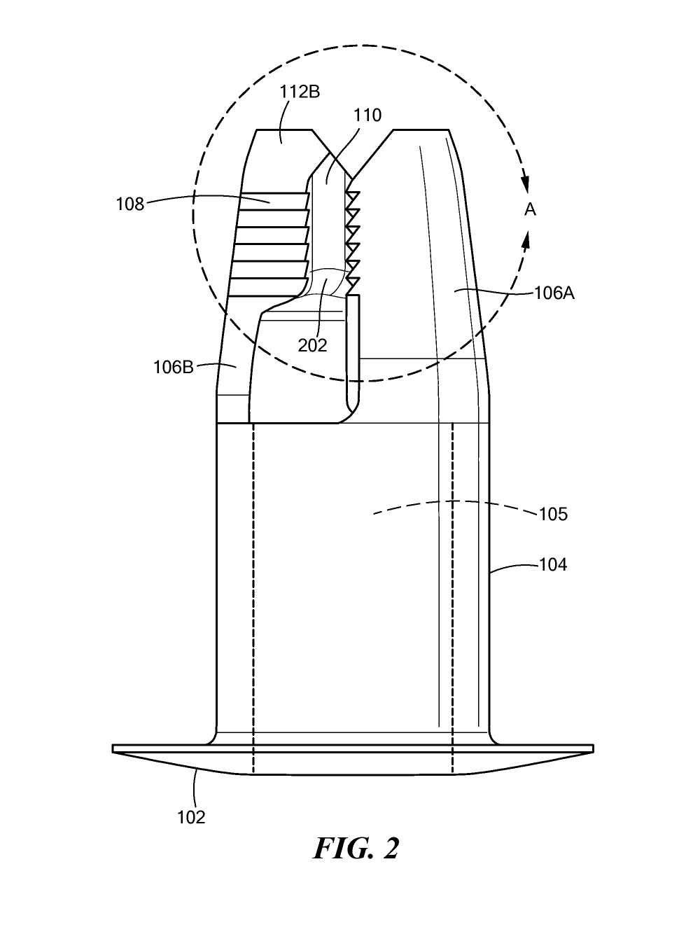

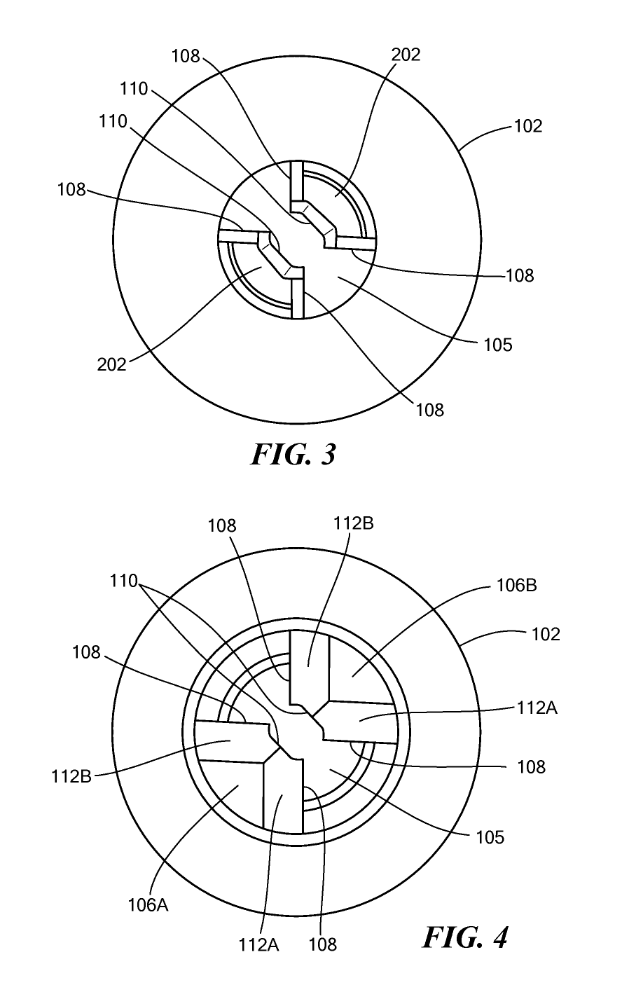

As shown in FIGS. 2 and 3, a flange 202 is located at the base of the removal tool guide portion 110. As will be described below, the flange 202, located on each prong 106A, 106B is used to allow a tool to disengage one part 100 from another. Looking through the opening 105 from the extension rim 102, in a direction as identified by the arrow 3 in FIG. 1, the flanges 202 of each of the prongs 106A, 106B can be seen in FIG. 3.

A view of the part 100 from the direction identified by the arrow 4 in FIG. 1 is shown in FIG. 4. Here, the orientation surfaces 112A, 112B of each of the prongs 106A, 106B can be seen.

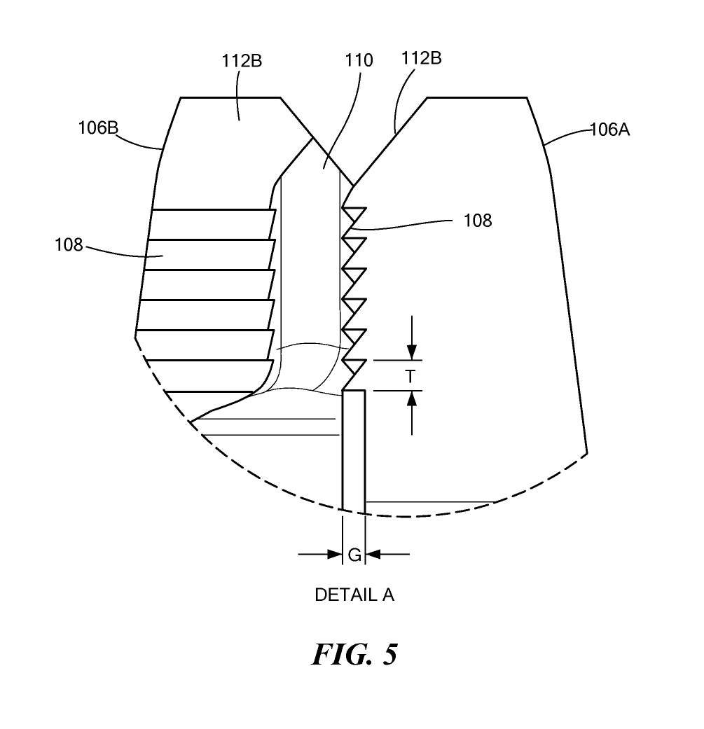

As shown in FIG. 5, a magnified view of the circle A shown in FIG. 2, the rows of teeth 108 have a pitch T of about 0.032 inches and an overhang G of approximately 0.020 inches. Overall, the part 100 has a length of approximately 1.138 inches and the diameter of the body is about 0.50 inches. Of course, these dimensions are exemplary only and not intended to limit the scope of the appended claims.

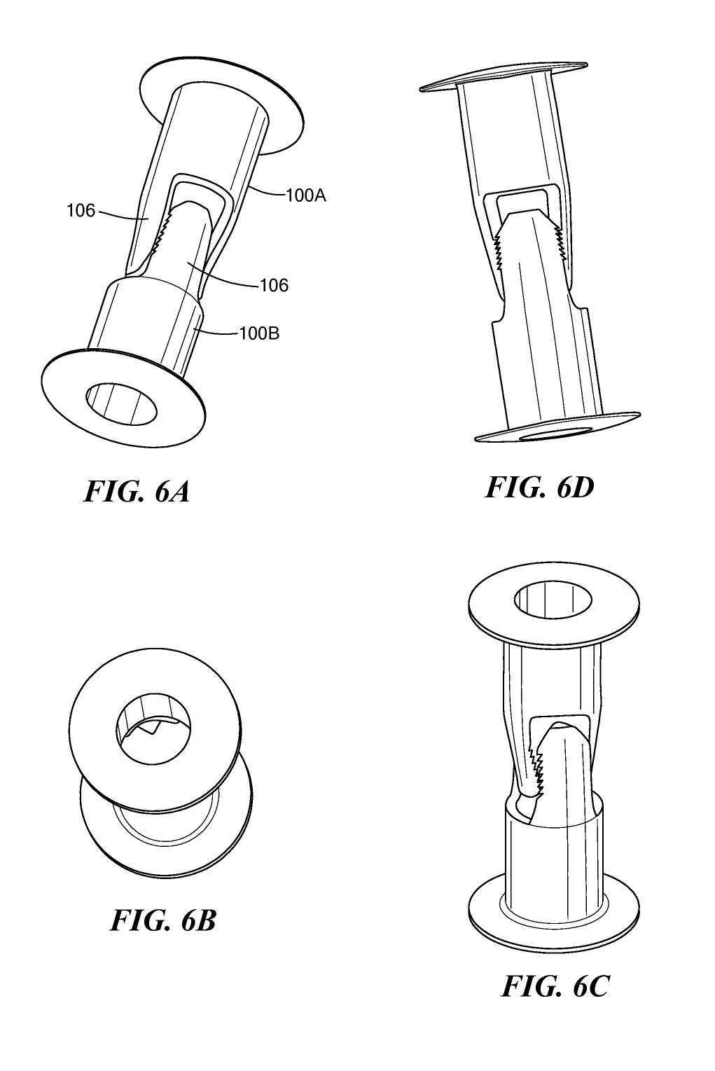

Referring now to FIGS. 6A-6D, two parts 100A, 100B are shown interconnected with one another. As can be seen, the prongs 106 of the parts 100A, 100B are directed towards one another, and by operation of the orientation surfaces 112A, 112B, the prongs 106 slide along the opposite set of prongs 106 and the teeth 108 engage in a ratchet mode of operation. Thus, as each part 100A, 100B is pushed toward the other, more teeth, i.e., rows of teeth, are engaged. The engaged parts can therefore accommodate a range of thicknesses, in increments of the tooth pitch or space between the teeth, between the two extension rims 102 of the engaged parts 100.

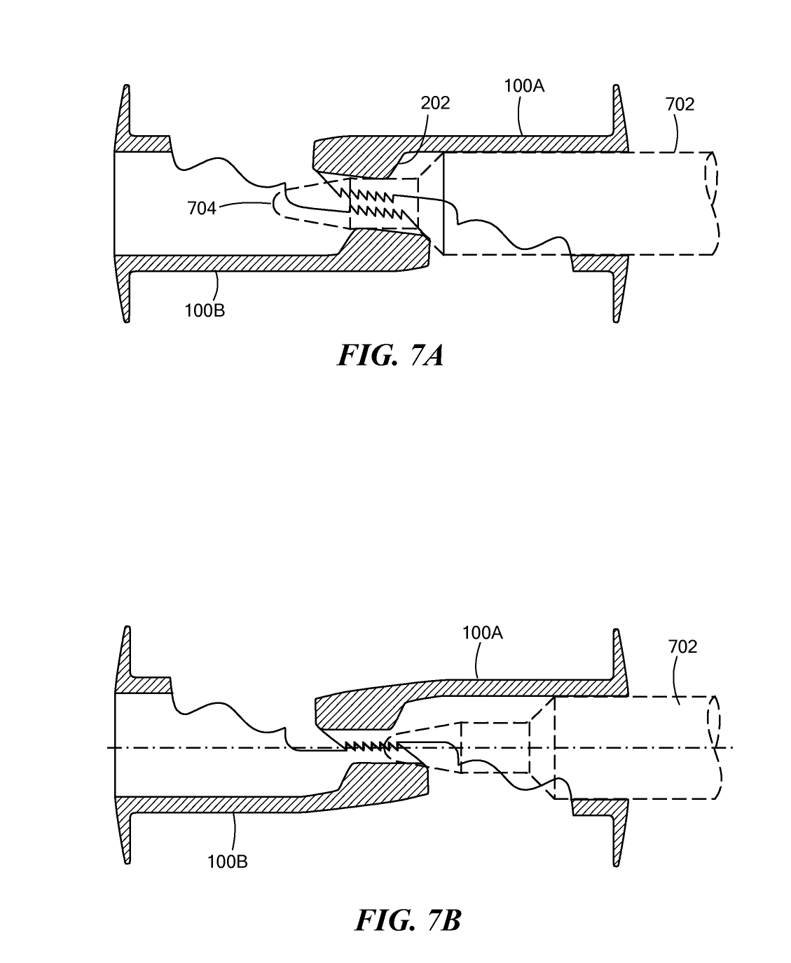

In order to disengage two parts 100A, 100B from one another, a tool 702, as shown in FIGS. 7A, 7B is pushed through either one of the two parts 100A, 100B. The tool 702, when inserted through the hole in the extension rim 102 of the part 100A, will contact the flanges 202 and cause the prongs 106A, 106B to spread apart. The tool 702 has a tool tip 704 that is curved and sized to slide along the flange 202. The tool 702 is guided by the removal tool guide portion 110 that causes the set of prongs 106A, 106B of the part 100A, as well as the prongs of the part 100B, to widen, thus disengaging its teeth 108 from the teeth 108 of the other part 100B. In this state, the two parts 100A, 100B, with the tool 702 disposed within part 100A, can be disconnected or separated from one another. When the tool 702 is removed from the part 100A, as shown in FIG. 7B, the teeth 108 of the two parts 100A, 100B engage once again. When the tool 702 is pressing against the opened prongs 106A, 106B, for example, the part 100A will tend to cling to the tool 702 and can then be removed from its respective opening by withdrawing the tool 702.

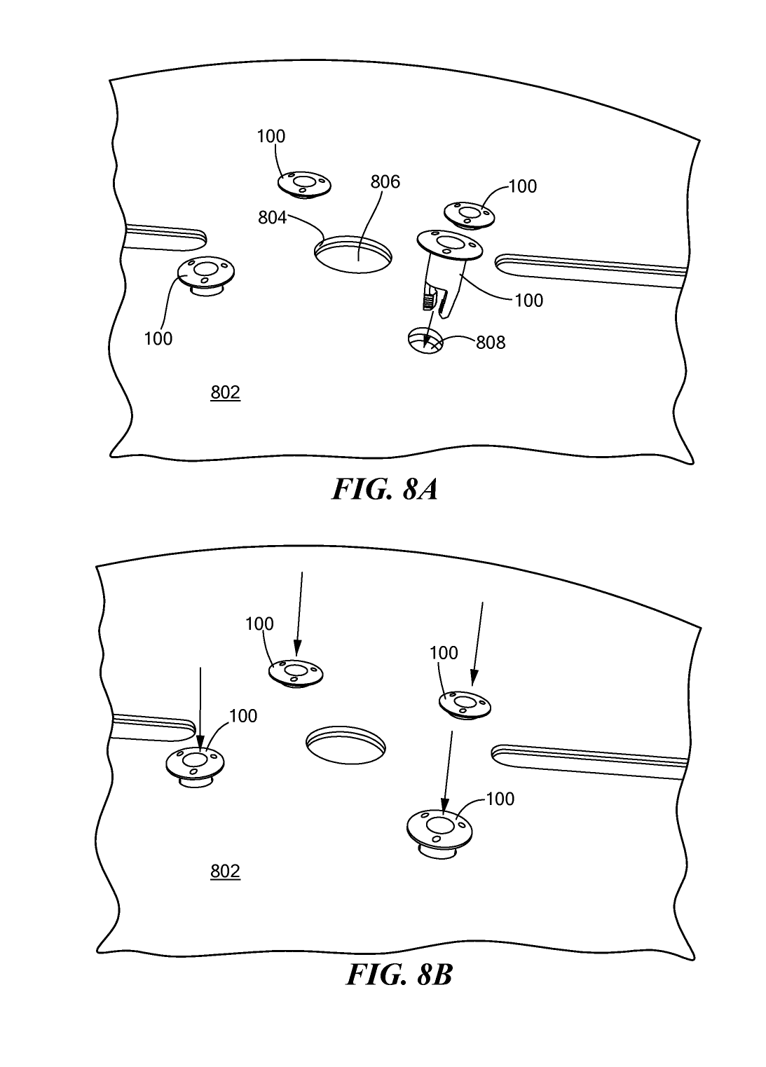

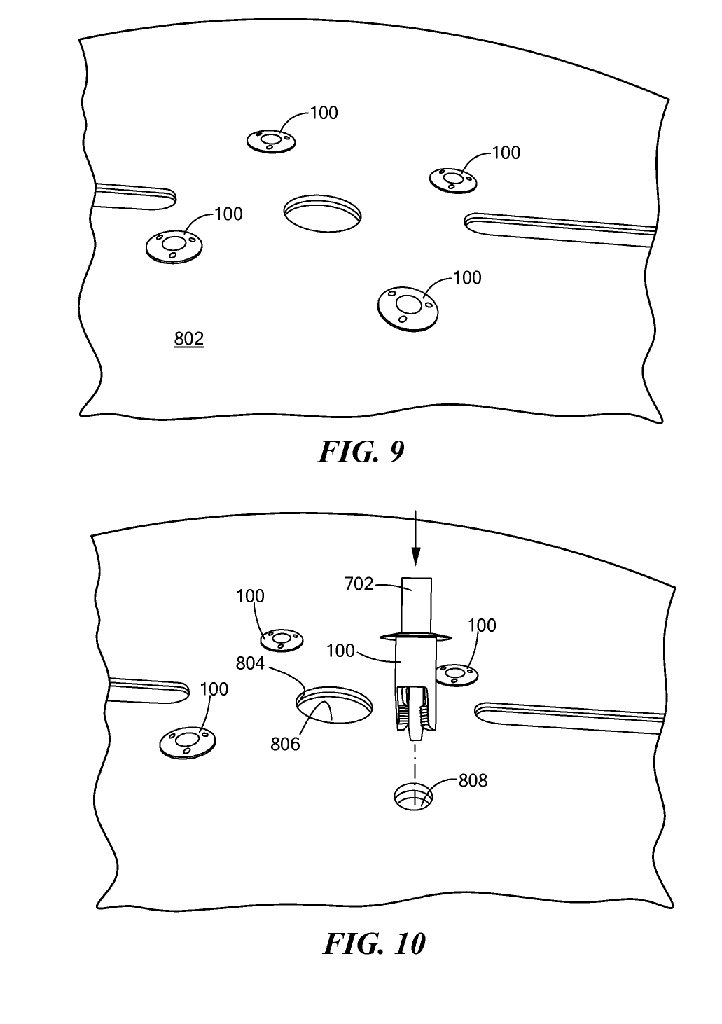

In one application, four pairs of parts 100 are used to assemble a reel 802 comprising two cardboard flanges 804 surrounding a core 806, as shown in FIGS. 8A and 8B. It should be noted that only one of the cardboard flanges 804 is shown. One part 100 is pushed into the hole, as shown in FIG. 8B, and is united with the other part already placed in the hole from the opposite side. When the part 100 is inserted in the same hole from each side of the reel 802, the teeth 108 of each of the parts 100 engage to keep the two cardboard flanges 804 pressed against the core 806, as shown in FIG. 9.

Advantageously, the orientation surfaces 112A, 112B of each part 100 will slide along the orientation surfaces 112A, 112B of the other part 100 to cause one or both of the parts 100 to rotate thus allowing the prongs 106 to align with the opposite space, so that the teeth will engage. This reduces the amount of time it takes to connect the two parts as no visual alignment is necessary in order for the parts to engage. Once the parts 100 are connected, as shown in FIG. 9, the stack of two cardboard flanges 804 and the core 806 remain coupled together.

To remove, i.e., disassemble, the reel 802, the tool 702 is used to spread the prongs 106 of one part 100, thereby disconnecting its teeth from the other part 100, and allowing it to be removed from its hole, as shown in FIG. 10. Similar to that which has been described above, the part 100 clings to the tool 702 and, advantageously, once disengaged from the other part, can be removed by pulling back on the tool 702. Thus, in order to disassemble the reel 802, one need only insert the tool 702 in one of the parts 100 in order to disengage each pair of parts.

The removal tool 702, by its spreading of the prongs 106 of the part 100 in which it is inserted, will also have the prongs of the other part pressed against it. When the tool 702 is withdrawn, the other part 100 (the one in which the tool is not inserted) will remain in place as it is on the other side of, in the example, the reel 802.

If the side opposite of the side from which the tool 702 is inserted into the part 100A, for example, is unrestrained, the tool 702 will particularly push out the part 100B on the opposite side. This allows for the relatively easy removability of the part 100B while the part 100A through which the tool 702 is inserted will cling to the tool 702 allowing it, the part 100A, to be removed as the tool 702 is withdrawn.

To facilitate removal of the part 100, the sides of the prongs 106 are curved toward the center so that when spread by the tool 702 they will not exceed the diameter of the body, for example, 0.5 inches. Advantageously, the dimensions of the holes in the core 806 can be predetermined and made to be just large enough to insert the fastener.

It should be noted that the types of materials and the number of layers of materials that can be fastened are not limited to two layers of cardboard flanges and a core as this is only set forth as a non-limiting example of an application of an embodiment of the present invention.

The part 100 is made from a suitable material such as a plastic, for example, or other similar material. While specific sizes may have been identified for one embodiment of the present invention, one of ordinary skill in the art will understand that the part may be made of any size that is practical. It will also be understood that the part may be made of many different materials other than plastic, although plastic is advantageous for its ease of fabrication, typically by injection molding, and for its relatively low cost.

In an another embodiment of the present invention a “single tooth” on each fastener is used for coupling and decoupling.

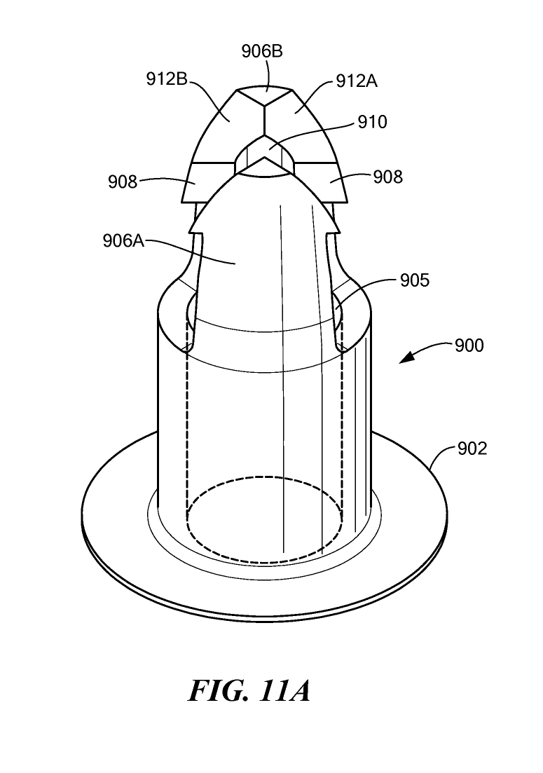

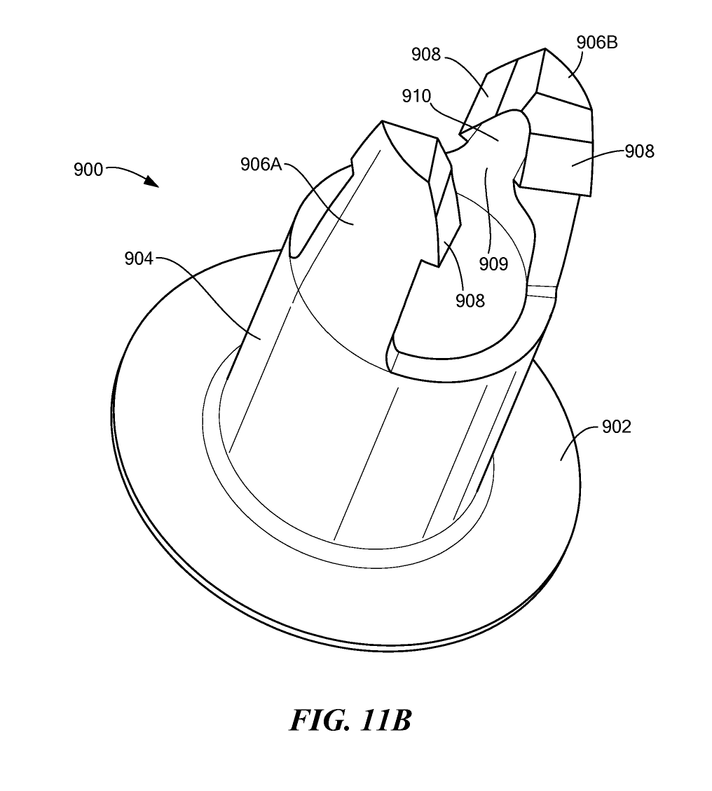

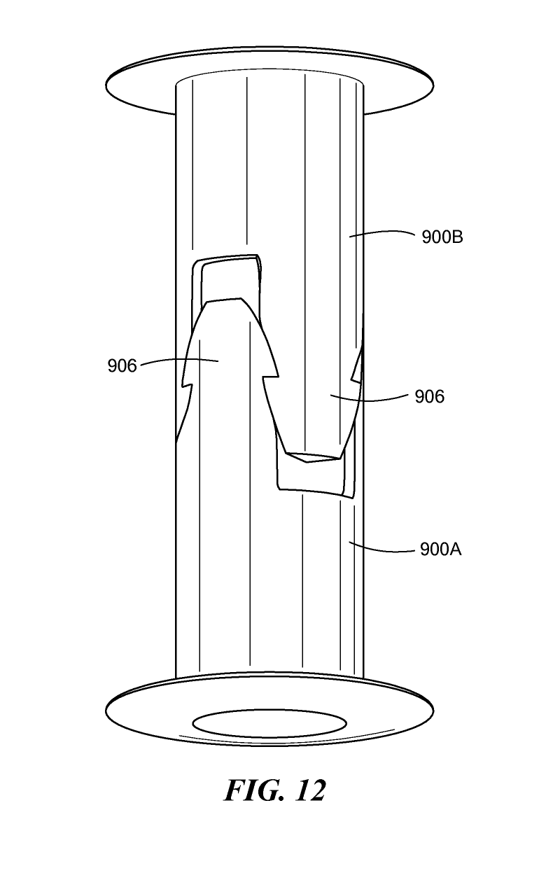

Referring now to FIGS. 11A and 11B, a part 900 includes an extension rim 902, or cap, connected to a hollow cylindrical body 904. The extension rim or cap 902 may be integral with the body 904 or a separate part that is attached to the body 904. Two identical prongs 906A, 906B, or engaging structures, extend from the cylindrical body 904 and are in opposition to one another. An opening 905 runs through the cylindrical body 904 with a corresponding hole in the extension rim 902. Each prong 906A, 906B includes a single tooth 908 disposed about a removal tool guide portion 910. Each prong 906A, 906B includes two orientation surfaces 912A, 912B that are used to guide the prongs 906 from one part 900A into a space between the prongs 906 of another part 900B when connected, as shown in FIG. 12 and as will be described in more detail below.

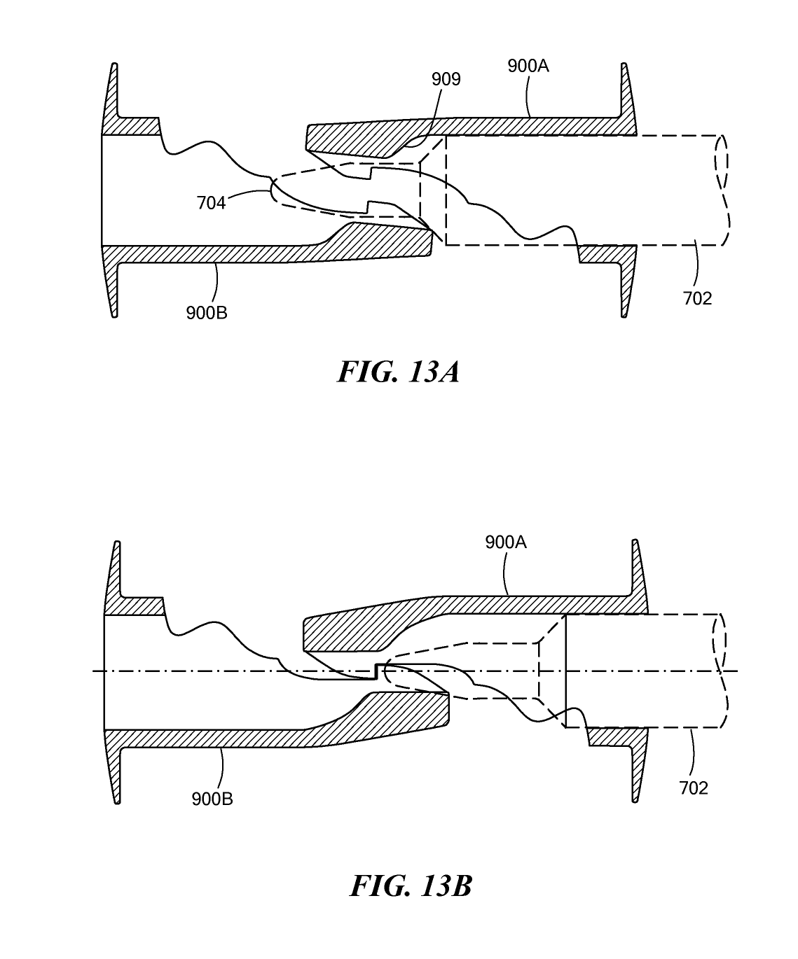

In order to disengage two parts 900A, 900B from one another, the tool 702, as shown in FIGS. 13A, 13B is pushed through either one of the two parts 900A, 900B. The tool 702, when inserted through the hole in the extension rim 902 of the part 900A, will contact a flange 909 and cause the prongs 906A, 906B to spread apart. The tool 702 has a tool tip 704 that is curved and sized to slide along the flange 909. The tool 702 is guided by the removal tool guide portion 910 that causes the set of prongs 906A, 906B of the part 900A, as well as the prongs of the part 900B, to widen, thus disengaging its teeth 908 from the teeth 908 of the other part 900B. In this state, the two parts 900A, 900B, with the tool 702 disposed within part 900A, can be disconnected or separated from one another. When the tool 702 is removed from the part 900A, as shown in FIG. 13B, the teeth 908 of the two parts 900A, 900B engage once again. The tool 702 can be sized to retain the disengaged part 900B, in the example, due to the tool 702 pressing against the opened prongs such that the part 900A can be removed from its respective opening by the tool.

As a variation of either of the embodiments, the two prongs 106A, 106B or 906A, 906B, need not be identical in order for the fastener to function. In one embodiment, for example, only one of the prongs may have the flange 202, 909 and the other does not. It is expected that as long as one prong includes the flange 202, 909 the removal tool, if properly shaped, will be able to spread the prongs and release the fastener.

Further, if a more permanent connection is desired, or at least one that is not easily removed, then blocking features may be provided within the cylindrical body part 104, 904. These blocking features may include protuberances that extended from the inner wall of the body part lumen and block access of the tool 702. Still further, the cap 102, 902 may be a solid piece, i.e., without a hole to access the lumen of a hollow body part 104, 904 or a plug may be glued or welded in place to block the hole. Thus, where the cap 102, 902 is solid but the body part 104, 904 is hollow, in order to disconnect the two pieces, a hole would have to be drilled in order for the removal tool 702 to be inserted. Still further, the size of the hole in the cap may be made so small than any implement that would fit through the hole would not be large enough to expand the prongs.

The removal tool 702 may be made of the same material as the part, for example, a suitable plastic or it may be of a metal such as, for example, aluminum.

Having thus described several features of at least one embodiment of the present invention, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A fastener, comprising:
a cylindrical body with first and second ends;
a first engaging structure extending from the first end; and
a second engaging structure extending from the first end;
wherein each of the first and second engaging structures comprises a first portion that is configured to interface with a corresponding first portion of another fastener.

2. The fastener of claim 1, wherein:
each of the first and second engaging structures comprises a first ratchet portion that is ratchedly connectable to a corresponding first ratchet portion of another fastener.

3. The fastener of claim 2, wherein each of the engaging structures further comprises a second ratchet portion that is ratchedly connectable to a corresponding second ratchet portion of the other fastener.

4. The fastener of claim 2, wherein the first ratchet portion comprises a plurality of rows of teeth.

5. The fastener of claim 2, wherein each of the first and second engaging structures is disposed about a circumference of the first end.

6. The fastener of claim 3, wherein each of the first and second ratchet portions of the first and second engaging structures comprises a plurality of rows of teeth, and
wherein a guide portion is disposed between the first and second ratchet portions on each of the first and second engaging structures.

7. The fastener of claim 6, wherein a flange is provided adjacent each guide portion.

8. The fastener of claim 2, further comprising an extension rim disposed about the second end.

9. The fastener of claim 2, wherein the housing and the first and second engaging structures are a unitary construction.

10. The fastener of claim 9, wherein the unitary construction comprises a plastic.

11. The fastener of claim 2, wherein the cylindrical body is hollow and has a lumen therethrough.

12. The fastener of claim 11, further comprising at least one protuberance extending from an inner wall of the lumen.

13. The fastener of claim 11, further comprising:
a solid cap attached to the second end of the cylindrical body,
wherein the solid cap has a diameter larger than a diameter of the cylindrical body.

14. The fastener of claim 11, further comprising:
a cap attached to the second end of the cylindrical body,
wherein the cap comprises an opening in line with the lumen of the cylindrical body, and
wherein the cap has a diameter larger than a diameter of the cylindrical body.

15. The fastener of claim 1, wherein:
each of the first and second engaging structures comprises a first tooth that is configured to interface with a corresponding first tooth of another fastener.

16. The fastener of claim 15, wherein each of the engaging structures further comprises a second tooth that is configured to interface with a corresponding second tooth of the other fastener.

17. The fastener of claim 15, wherein each of the first and second engaging structures is disposed about a circumference of the first end.

18. The fastener of claim 16, wherein a guide portion is disposed between the first and second teeth on each of the first and second engaging structures.

19. A fastener, comprising:
a cylindrical housing having first and second ends; and
a pair of prongs disposed in opposition to one another about a circumference of the first end of the housing;
each prong comprising:
a symmetric pair of rows of teeth disposed along a portion of the respective prong;
a tool guide portion disposed between the rows of teeth; and
a guide flange adjacent the tool guide portion,
wherein each tool guide portion of a respective prong is located opposite the other tool guide portion.

20. The fastener of claim 19, wherein each row of teeth is aligned with a radius extending from a center axis of the cylindrical housing.

21. The fastener of claim 19, wherein the housing and the pair of prongs are a unitary construction.

22. The fastener of claim 19, wherein the housing and the prongs are made from plastic.

23. The fastener of claim 19, further comprising an extension rim disposed about the second end of the housing.

24. The fastener of claim 19, wherein the cylindrical housing is hollow and has a lumen therethrough.

25. The fastener of claim 24, further comprising at least one protuberance extending from an inner wall of the lumen.

26. The fastener of claim 24, further comprising:
a solid cap attached to the second end of the cylindrical housing,
wherein the solid cap has a diameter larger than a diameter of the cylindrical housing.

27. The fastener of claim 24, further comprising:
a cap attached to the second end of the cylindrical housing,
wherein the cap comprises an opening in line with the lumen of the cylindrical housing, and
wherein the cap has a diameter larger than a diameter of the cylindrical housing.

28. A fastener, comprising:
a cylindrical housing having first and second ends; and
a pair of prongs disposed in opposition to one another about a circumference of the first end of the housing;
each prong comprising:
a pair of teeth disposed along a portion of the respective prong;
a tool guide portion disposed between the teeth; and
a guide flange adjacent the tool guide portion,
wherein each tool guide portion of a respective prong is located opposite the other tool guide portion.

29. The fastener of claim 28, wherein each pair of teeth is aligned with a radius extending from a center axis of the cylindrical housing.

30. The fastener of claim 28, wherein the housing and the pair of prongs are a unitary construction.

31. The fastener of claim 28, further comprising an extension rim disposed about the second end of the housing.

32. The fastener of claim 28, wherein the cylindrical housing is hollow and has a lumen therethrough.

33. The fastener of claim 32, further comprising:
a cap attached to the second end of the cylindrical housing,
wherein the cap has a diameter larger than a diameter of the cylindrical housing, and
wherein the cap is one of: solid or comprises an opening in line with the lumen of the cylindrical housing.
